(19) United States
(12) Patent Application Publication
(10) Pub. No.: US 2018/0089430 A1
(43) Pub. Date: Mar. 29, 2018

(54) COMPUTER SECURITY PROFILING

(71) Applicant: 1E Limited, London (GB)

(72) Inventor: Andrew MAYO, London (GB)

(21) Appl. No.: 15/711,395

(22) Filed: Sep. 21, 2017

(30) Foreign Application Priority Data
Sep. 23, 2016 (GB) 1616236.4

(51) Int. Cl. G06F 21/56; G06F 21/57; G06F 21/55

(52) U.S. Cl. CPC G06F 21/562; G06F 21/60; G06F 21/552; G06F 21/577

(57) ABSTRACT

Certain examples described herein relate to security profiling files on a computer system, including determining a similarity between two executable program files. Byte samples are obtained from each executable program file, respective distributions of byte values are determined, and a difference metric between said distributions is determined, for example by a byte sampler. Responsive to the difference metric indicating a similarity, file import sections of the executable program files are processed to determine a set of application programming interface references for each executable program file. A similarity metric is determined as a function of a number of matching entries in the sets of application programming interface references, and responsive to the similarity metric indicating a similarity between the application programming interface references, an indication is made to a computer security utility that the executable program files are similar.

### CROSS-REFERENCE TO RELATED APPLICATIONS

This application claims priority to UK Application No. GB1616236.4, filed Sep. 23, 2016, under 35 U.S.C. § 119(a). Each of the above-referenced patent applications is incorporated by reference in its entirety.

### BACKGROUND OF THE INVENTION

### Field of the Invention

The present invention relates to the profiling of executable program files on a computer system, and in particular to determining whether an executable program file is a security threat to the computer system, or can be run safely.

### Description of the Related Technology

Modern computer systems are continually under threat from malware, or malicious software: computer programs which seek to cause harm to a computer system, or stealthily gather information about the system or its user(s) and their activity, amongst other purposes.

Malware, such as a computer virus or Trojan horse, may misrepresent itself as another type of file or as originating from another source in an attempt for the user or system to run the malware program. Malware may also target and exploit vulnerabilities in software already installed on the computer system, such as in files associated with the operating system, application programs, or plugins. For example, installed software may contain flaws such as buffer overflows, code injections (SQL, HTTP etc.), or privilege escalation. Such a flaw can lead to a vulnerability that exposes the installed software program and its host computer system to attack by malware.

Exposure of a computer system to the internet, and the ubiquity of downloads therefrom, has increased the number and scale of opportunities available for malware designers to exploit and attack computer systems.

As malware has developed, so has the software used by users and system managers to protect themselves and their systems from the potential intrusion and disruption malware attacks can cause—commonly called anti-virus or anti-malware software.

However, known security systems and methods can still fail to differentiate between a malicious file from a file that can be trusted and is safe to run on the system. For example, some known methods of malware protection use metadata within program files such as a signature or certificate of source to determine if the file can be trusted for executing safely. However, metadata is prone to alteration by an attacker, and signatures or certificates can be forged, particularly if the metadata is not cryptographically secure.

It is desirable to improve such security systems and methods for security profiling executable program files on a computer system, including identifying similar files, to improve reliability and thus make computer systems more secure.

### SUMMARY

Aspects of the present invention are set out in the appended claims.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing the components of a computer security profiling system according to an example;

FIGS. 2 and 3 are schematic diagrams, each showing a simplified representation of an executable program file comprising bytes according to an example;

FIG. 4 is a schematic diagram showing a graphical representation of a byte value distribution according to an example;

FIG. 5 is a schematic diagram showing a simplified representation of information associated with an executable program file according to an example;

FIG. 6 is a flow diagram showing a method for determining a similarity between two executable program files according to an example;

FIG. 7 is a schematic diagram showing the components of a computer system comprising a computer security profiling system, according to an example; and

FIG. 8 is a schematic diagram showing the components of a computer system comprising a computer security profiling system, according to another example.

### DETAILED DESCRIPTION OF CERTAIN INVENTIVE EMBODIMENTS

The term “software” as used herein refers to any tool, function or program that is implemented by way of computer program code other than core operating system code. In use, an executable form of the computer program code is loaded into memory (e.g. RAM) and is processed by one or more processors. “Software” includes, without limitation: non-core operating system code; application programs; patches for, and updates of, software already installed on the network; and new software packages.

A computer system may be, for example: a computing device such as a personal computer, a hand held computer, a communications device e.g. a mobile telephone or smartphone, a data or image recording device e.g. a digital still camera or video camera, or another form of information device with computing functionality; a network of such computing devices; and/or a server.

Modern computer systems typically have installed on them a variety of executable software, such as application programs, which have been chosen by a user or system manager to be stored on, or accessible by, a computer system for running when desired, to provide its particular functionality. This software will generally originate from wide variety of sources i.e. different developers and producers, and may be obtained by different means e.g. downloaded, or installed from disk or drive.

Application programs may comprise one or more executable program files. An executable program file comprises encoded instructions that the computer performs when the file is executed on the computer. The instructions may be “machine code” for processing by a central processing unit (CPU) of a computer, and are typically in binary or a related form. In other forms, the instructions may be in a computer script language for interpreting by software. Different operating systems may give executable program files different formats. For example, on Microsoft Windows® systems the Portable Executable (PE) format is used. This format is a data structure that is compatible with the Windows® operating system (OS) for executing the instructions comprised in an executable file. On OS X® and iOS® systems, the Mach-O format is used. Another example is the Executable and Linkable Format (ELF). Different operating systems may also label executable program files with a particular filename extension, for example on the Windows® OS executable program files are typically denoted by the .exe extension.

Modern computer systems typically also have tools to assist in protecting them from threats, such as malware, that may infiltrate the computer system, for example via an internet or other network connection. Such tools may, for example, scan the computer system for any executable program files that are unknown, or have a known vulnerability or malicious infection.

In some examples of such security tools, the computer system employs a whitelist: a list of software permitted to run on the computer system. Thus, if an executable program file is identified that is not on the whitelist, then it may not be permitted to run on the computer system. Whitelisting is therefore used to tell the computer system which application programs are safe to run. The converse, blacklisting, comprises restricting execution of an executable program file if it appears i.e. matches an entry, on the blacklist. Thus, known malicious files can be identified and prevented from running on the computer system. Whitelisting may be considered more secure than blacklisting since a file must first be allowed, for example by the user, and added to the whitelist before it may be executed. With blacklisting, a potentially malicious file may be executed unwantedly because it had not been identified as malicious. However, although whitelisting may have security benefits over blacklisting, whitelisting is more likely to restrict a safe program. Such restriction may be inefficient for a user or computer system manager when numerous innocuous files, such as updates and patches for software already installed, require manual security clearance before being executed.

Thus, there can often be conflict between a user (or system manager) installing more software on a computer system for added functionality (with that software getting updates and/or patches comprising further executable program files on the computer system) and the tools such as an installed anti-malware system and/or a whitelist/blacklist deciding what can and cannot be executed on the system. Thus, a patch for a trusted application program, or even for the operating system (OS) of the computer itself, would likely need to prove its identity as a harmless patch for a trusted application program to the computer security tool(s) in order to be permitted to be executed on the computer and/or added to the whitelist. For example, some known methods of security profiling an executable program file use metadata of the file to identify a signature or certificate of source. An executable program file carrying an authenticated certificate or signature would thus be allowed to run on the computer system and may be automatically added to the whitelist. However, such metadata is prone to alteration or forgery by an attacker, particularly if the metadata is not cryptographically secure.

A useful way of security profiling a file i.e. recognizing the file's identity, and determining if it is safe or dangerous to run on the computer system, is to compare it to a file of known identity and character. For example, a file comprising an update or patch for an application program installed on a computer system could be identified as safe if it were compared against the parent application program file and found to be similar enough that it is likely to be from the same source. If the parent application was on a whitelist, then after being found to be similar, the update or patch may be added automatically to the whitelist. In an alternative example, a file could be identified as potentially harmful if it were compared to a known malware or virus executable file and found to be similar. If the latter were on a blacklist, then the former may be automatically added to the blacklist.

However, known security systems and methods can still fail to identify when two files are similar. For example, virus detection and whitelisting methods often use file hashes to identify and compare files. File hashes are values outputted by a hash function which operates on data in a file. For example, a consistent hash function may be used to map files to hashes. Comparison of files may therefore be done by comparing the corresponding hashes. However, the hash of a file can be easily modified, even by a single change to a byte value in the file, thus meaning that otherwise similar files can be minimally changed but not identified as similar by comparison of their file hashes. Alternative approaches use rolling hashes in an attempt to group similar or related files. However, reordering code blocks in a file would give a different rolling hash, meaning files that are similar may not be identified as such. Thus, there is unreliability in the known systems and methods which can cause errors, such as patches and updates for safe and trusted programs being prevented from execution due to a false negative in the security profiling, and/or harmful programs disguised as patches being run.

The present invention provides a computer security profiling system and related methods that allow an executable program file, for example an unrecognized file found in a scan like the one described, to be compared to a software file on the computer system already identified as safe, for example whitelisted, and to determine whether those files are similar or related. If they are, the new file may be added automatically to the whitelist of the computer system, and therein automatically permitted to run on request by the kernel of the OS. The converse is also possible, for example comparing a suspect file to a known malware or the like, for example a blacklisted file, and to determine whether or not those files are similar or related. If they are, the new file may be added to the blacklist of the computer system automatically, and therein not permitted to run on request by the kernel of the OS.

The presently provided computer security profiling system and related methods are advantageously faster and more reliable in determining similarity or relation between files, when compared with known systems and methods, particularly those employing file hashes which require individual computation and comparison.

The computer security profiling system and/or related methods may be implemented, in an example embodiment, as part of a computer device such as a personal computer, a hand held computer, a communications device (e.g. smartphone) etc. Thus, if a new file is transferred to the computer device, for example by internet download, the computer security profiling system and/or methods may determine whether that file is similar to a file of known character on the system and therefore whitelist/blacklist the new file accordingly.

For example, an update or patch for an application program installed on the computer system may be downloaded. A patch may comprise a replacement executable program file for the installed application program, or may be applied to transform the current executable program file, for example a Microsoft® Installer (MSI) Patch (MSP). Thus, a “patch” as herein described may refer to the replacement, or transformed, executable program file. The computer security profiling allows for a reliable determination that the downloaded update or patch is similar or related to the installed application program. An indication of similarity may be provided to a computer security utility, a system software functioning to maintain the security of the computer system, which may then control execution of the update or patch i.e. allow it to run on the computer system. In some examples, the installed application program may be whitelisted on the computer system, and upon determination that the downloaded update or patch is similar or related to the application program, the update or patch may be automatically whitelisted so that it may be run without hindrance. This allows setting up whitelists to be more efficient and reliable, as only major release versions of application programs need to be specified as allowed, and the computer security profiling system and/or related methods may determine, for all patched versions and updates, whether there is similarity between the patched version and the exemplar (allowed) version. In known methods and systems for setting up whitelists, relying on signed file metadata is undesirable due to the unreliability described, and using file hashes to determine file similarity requires a large set of hashes to allow new patched versions of software to be whitelisted, which is very inefficient and susceptible to errors in practice.

The present system and/or related methods provide for adaptive whitelisting: if a software application is whitelisted and allowed to run on the computer system, then any related version may be whitelisted automatically, without any manual intervention required.

In other embodiments, the computer security profiling system and/or related methods may be implemented as part of a server on a network. The server may be communicatively coupled to a network, such as a local area network (LAN) or wide area network (WAN) and/or wireless equivalents, with one or more computer devices also connected to the network. Each computer device may have: its own software, for example an operating system (OS) and application programs; and its own hardware, for example CPU, RAM, HDD, input/output devices etc.

In some examples which utilize the computer security profiling system and/or related methods for whitelisting, the server may store a global whitelist, while each of the networked computer devices store a local whitelist. Each local whitelist comprises a list of application programs that are permitted to be run on the corresponding computer device, and may be maintained by the OS of the corresponding computer device. The global whitelist maintained by the server also comprises a list of application programs that are permitted to be run on the computer devices, and is enforced throughout the network as a policy. For example, the kernel of each networked computer interacts with the local whitelist and with the server to prevent execution of software absent from the combination of the local whitelist and global whitelist.

In some examples, the local whitelist comprises the global whitelist such that, as a minimum, a networked computer is prevented from running software absent from the global whitelist at least. In some examples, the server produces the local whitelists for storing on the networked computers. This may be enabled by each networked computer having a monitoring program installed which sends data relating to the software installed on the computer to the server.

Thus, while computer security profiling system and/or related methods may run on a local computer, as described, to automatically whitelist versions of software related to versions already whitelisted, so too may the system and/or methods run on a server to automatically update the local and/or global whitelists.

In some examples, the computer security profiling system comprised in the server may intercept calls on the local computers, for example by the operating system, to execute or run a program on the computer that is unknown. The program file may then be suspended from being executed while it is inspected: the file may be processed by the computer security profiling system and/or methods, and thereafter prevented or allowed to run depending on an indication of similarity or dissimilarity between the program file and one or more known files.

In other embodiments, the computer security profiling system may scan, periodically or on command, one or more files, directories, or an entire computer device or network of multiple computer devices, for files which may be prejudicial to the security of the computer system. The present system and methods allow, for example, a quick and efficient determination of whether an arbitrary file on the system found during scanning is similar or related to vulnerable software, even if its filename and/or extension may differ. Existing file hashing methods, again, are hindered by the library of hashes that are required and cannot ‘fail safe’: if the hash is not in the library, the file will not be detected.

In some examples, the computer security profiling system may comprise a computer security utility which may scan and identify unknown or new files on the computer system (since the previous scan), which may then be analyzed by the present system and/or methods to determine whether the unknown or new files are malicious and/or vulnerable files. If the indication is that the files are threatening to the computer system, the files may be quarantined from the resources of the computer system. As the computer security profiling system and methods may be employed on an individual computer device, or on a server operating across a network of connected devices, the scanning may correspondingly occur on one computer device, or across at least part of a network. For example, in the network examples, the components of the network (local computers, shared storage, shared devices) may all be scanned. The identified unknown or new file(s) may be transferred to the server for analysis by the computer security profiling system to indicate whether the file(s) is safe to run on the device it was found on, or on the network generally. The output indication from the computer security profiling system may then be used to automatically update the local or global whitelist and/or blacklist.

In examples where the computer security profiling system and methods involve scanning for malicious software, the present system and methods allow a determination that a variant of an exemplar malware file is still related, even if it is altered from the original. Existing methods and systems rely on a library of file hashes, which can never be complete and account for all the possible variations of a malware file.

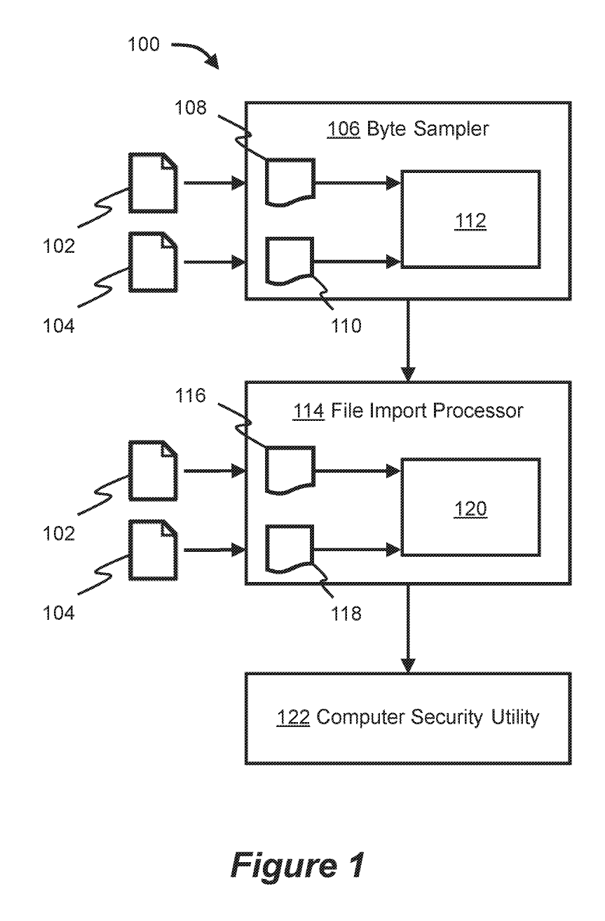

FIG. 1 shows an example of a computer security profiling system 100 according to an embodiment of the present invention. The computer security profiling system 100 comprises a byte sampler 106, a file import processor 114 and a computer security utility 122. In some examples, these features may each comprise computer program code that is run on a computer system comprising the computer security profiling system 100.

The byte sampler 106 is configured to access at least one file storage location, for example an internal data storage of a computer system, or a data storage device coupled to the computer system, such as a hard disk drive (HDD) or solid state drive (SSD), or a location thereon.

The byte sampler 106 is configured to obtain a byte sample from each of a first executable program file 102, and a second executable program file 104, which are located in the at least one file storage location. For example, the first executable program file 102 may be stored in a different storage location on the computer system to that of the second executable program file 104, or both executable program files 102, 104 could be stored in the same storage location. In an example, the first executable file 102 may be a software application that is permitted to run on a computer system, and the second executable file 104 may be an update to, or patch for, the software application of the first executable file 102, e.g. a full upgrade or replacement of the software application, or a transformation applied to the first executable file 102.

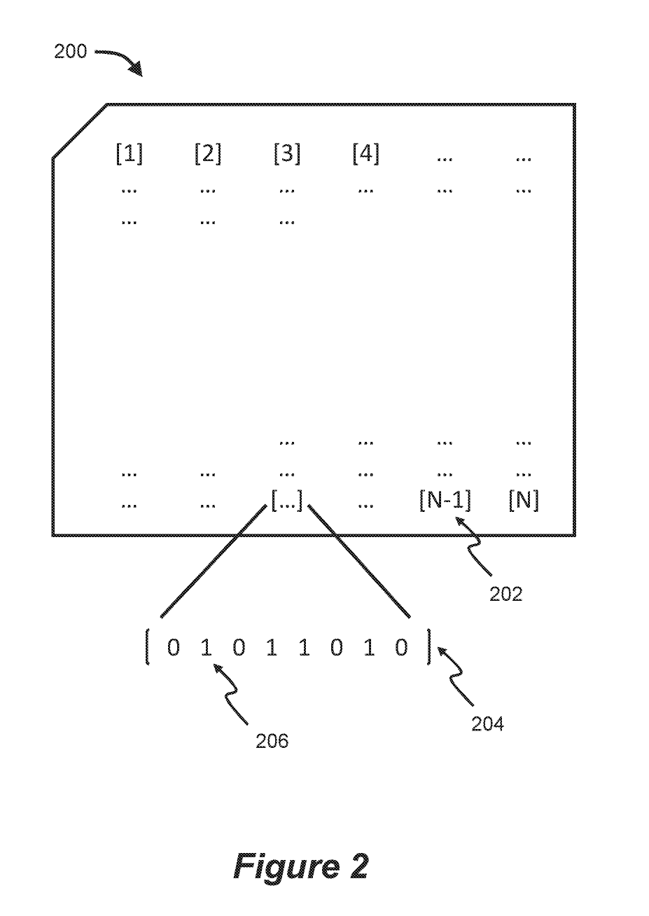

A schematic representation of an example executable program file 200 is shown in FIG. 2. The executable program file 200 may be an implementation of the first executable program file 102 or the second executable program file 104. The executable program file 200 comprises N bytes 204, each having an ordinal position 204 in the file. This is shown in FIG. 2 by labels [1], [2] . . . and so on, up to [N] denoting the position of each individual byte 202 in the file. Each byte 204 comprises eight bits 206 and so may be called an octet or 8-bit byte. In other examples, the bytes 204 may comprise a different number of bits 206, for example six. Each bit 206 is a binary digit or unit of digital information, having two possible values: zero (0) or one (1). Hence, an 8-bit byte 204 can have 2⁸=256 possible values based on the two hundred and fifty six possible iterations of eight units, each having two possible values. The value of a given 8-bit byte 204 can therefore be any integer between zero [0 0 0 0 0 0 0 0] and two hundred and fifty five [1 1 1 1 1 1 1 1]. As an example, byte 204 in FIG. 2 has a value of ninety (90) [0 1 0 1 1 0 1 0].

Referring back to FIG. 1, obtaining a first byte sample 108 from the first executable program file 102 may comprise selecting bytes comprised within the first executable program file 102, copying those bytes, and storing the copied bytes together as the first byte sample 108. Similarly, obtaining a second byte sample 110, this time from the second executable program file 104, may comprise selecting bytes comprised within the second executable program file 104, copying those bytes, and storing the copied bytes together as the second byte sample 110. The selection of bytes comprised in the first executable program file 102 and comprised in the second executable program file 104 may be arbitrary, or may follow a particular routine or method. For example, the sampling may be random or may be systematic. Whichever routine of selection is chosen, the same routine is used for selecting bytes in the first executable program file 102 and for selecting bytes in the second executable program file 104.

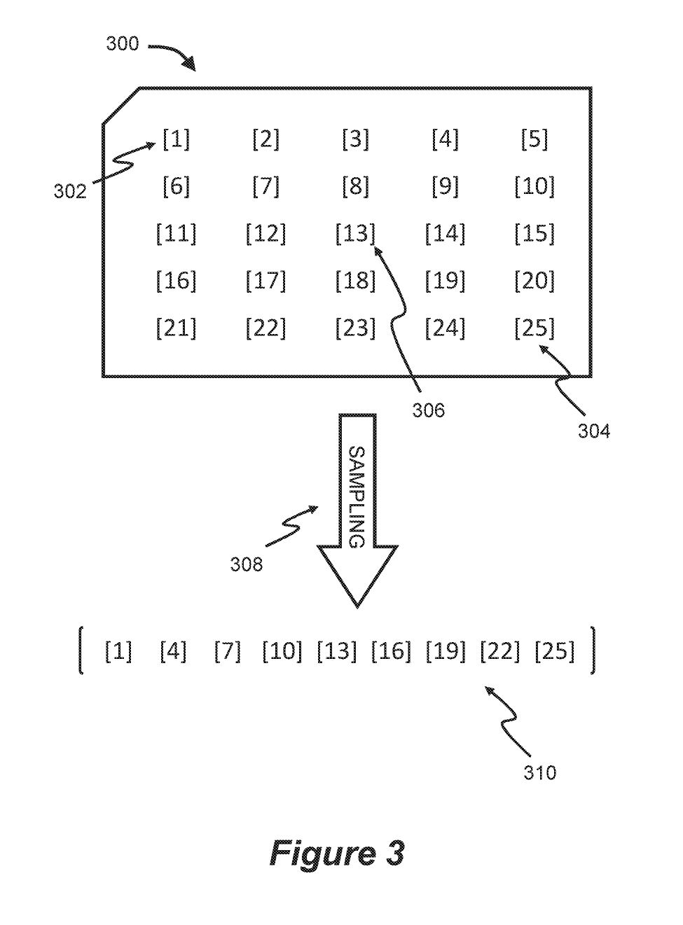

FIG. 3 shows an example of results from sampling equidistant bytes in an executable program file 300. In this example, the byte sampler 106 samples bytes that are equidistant from one another in the executable program file 300. The executable program file 300 may be an implementation of the first executable program file 102, the second executable program file 104, or any executable program file 200 as described previously. The example executable program file 300 comprises twenty five (25) bytes, shown in FIG. 3 by their ordinal location in the file 300, from the first byte 302 to the twenty fifth (and last) byte 304. The executable program file 300 shown in FIG. 3 therefore corresponds to the executable program file 200 in FIG. 2 with N=25.

In this example, the byte sampler 106 samples the executable program file 300 by a sampling process 308 in which the byte sampler 106 obtains a first boundary byte and a second boundary byte from the file 300, and recursively obtains a median byte from between each neighboring pair of previously obtained (i.e. boundary and/or median) bytes until a predetermined number of bytes is obtained. Thus, after each median byte is obtained it is added to the plurality of previously obtained bytes. In some examples, the first boundary byte may correspond to the first byte 302 of the executable program file 300 and the second boundary byte may correspond to the last byte 304 of the executable program file 300.

Effectively, there are initially two boundary bytes delimiting one set of bytes between them, then there are three boundary bytes delimiting two sets of bytes after the first median byte is obtained, and then there are five boundary bytes delimiting four sets of bytes after the second and third median bytes are respectively obtained from the previous two sets of bytes. This process of bisecting the sets of bytes as the median bytes are obtained is continued until the predetermined number of bytes is obtained. In these described examples, “obtaining” a byte may correspond to identifying and/or copying the identified byte. In some examples, the boundary and median bytes are all identified before being copied or extracted from the executable program file 300 simultaneously, whereas in other examples the boundary and median bytes are identified and copied or extracted from the executable program file 300 sequentially.

In FIG. 3 the predetermined number of bytes to be obtained is nine (9). The byte sampler 106 begins the sampling process 308 by obtaining the first byte [1] 302 and the last byte [25] 304 as the first and second boundary bytes, respectively, and then obtains the median byte 306 (i.e. the thirteenth byte [13]) from the set of twenty five bytes between the two boundary bytes 302, 304.

The byte sampler 106 recursively obtains a median byte from between each neighboring pair of previously obtained bytes until the predetermined number of nine bytes is obtained. The median byte [7] is obtained from the first set of eleven bytes [2] to [12] between the neighboring pair of previously obtained bytes [1] and [13], and the median byte [19] is obtained from the second set of eleven bytes [14] to [24] between the neighboring pair of previously obtained bytes [13] and [25]. The two sets of remaining bytes are each bisected to form four sets of five bytes in total, two from each set. The number of bytes obtained by the byte sampler 106 at this stage is five (5) which is less than the predetermined number of nine (9), and so the sampling process 308 is continued. The median bytes are obtained from each of the four sets of bytes, which constitute bytes [4], [10], [16] and [22]. The number of bytes obtained by the byte sampler 106 at this stage is nine (9) which equals the predetermined number, and so the sampling process 308 ceases i.e. is not repeated. The bytes [1], [4], [7], [10], [13], [16], [19], [22], and [25] in the resulting byte sample 310 are equidistant from one another in the executable program file 300: i.e. there are two bytes between each sampled byte in the executable program file 300. The bytes comprised in the sample 310 are thus distributed evenly across the executable program file 300.

In other examples, the executable program file 200, 300 may comprise many thousands of bytes, for example 100,000. The predetermined number of bytes may therefore be much larger than nine, for example 8,192 bytes may be sampled by the same sampling process 308 described above: beginning with byte [1] and [100,000] the median byte is [50,000]. This gives three sampled bytes. Sampling the median bytes between neighboring pairs of previously sampled bytes gives 5 sampled bytes: [1], [25,000], [50,000], [75,000], and [100,000]. This is repeated until 8,192 bytes have been sampled.

The byte sampler 106 is configured to determine a distribution of byte values for each of the first byte sample 108 and second byte sample 110, correspondingly obtained from the first executable program file 102 and the second executable program file 104. For example, the byte sampler 106 may comprise a distribution module 112 for determining the distribution of byte values in each of the executable program files 102, 104. The distribution of byte values may comprise data representing the frequency of each possible byte value in the byte sample. For example, for bytes comprising eight bits, each byte may have a value in the range 0 to 255, and so the distribution of byte values may comprise data representing the number of bytes in the sample that have a value of 0, 1, 2, . . . and so on up to 255.

The byte sampler 106 is also configured to determine a difference metric between the first and second byte value distributions. In some examples, this determination may be performed by the distribution module 112 comprised within the byte sampler 106. The difference metric is a value determined by the byte sampler 106 indicating the difference or similarity between the first and second byte value distributions. In some examples the difference metric value is a chi-squared value, or a derived value thereof such as a minimum chi-squared value, determined by chi-squared differences between the first and second byte value distributions. For example, a chi-squared value may be the output value of a chi-squared test:

$${χ}^{2} = \frac{1}{2} {\sum }_{i = 1}^{n} \frac{{( {x}_{i} - {y}_{i} )}^{2}}{( {x}_{i} + {y}_{i} )} ;$$

where χ² is the chi-squared value, and is calculated as shown in the equation by computing the difference between a distribution value xᵢ from the first byte value distribution and a corresponding distribution value yᵢ from the second byte value distribution, wherein index i denotes the position in the distribution. The difference is squared and divided by the sum of the distribution values xᵢ and yᵢ. This operation is summed over all positions i in the distribution, from i=1 to i=n, where n is the number of positions in the respective distributions. For example, in examples where the byte value distributions are histogram distributions, n may be the number of ranges or “bins” in the distribution.

The distribution values xᵢ, yᵢ in each byte value distribution may be normalized, for example by dividing the distribution value by the total sum of all distribution values in the respective byte value distribution. There may also be a test or check that (xᵢ+yᵢ) is non-zero during the chi-squared test example above, to prevent division by zero. In some examples, the sum shown above in the chi-squared test may not include a factor of ½. In some examples, the denominator may instead equal yᵢ.

Other correlation tests than the chi-squared tests described may be used to derive the difference metric.

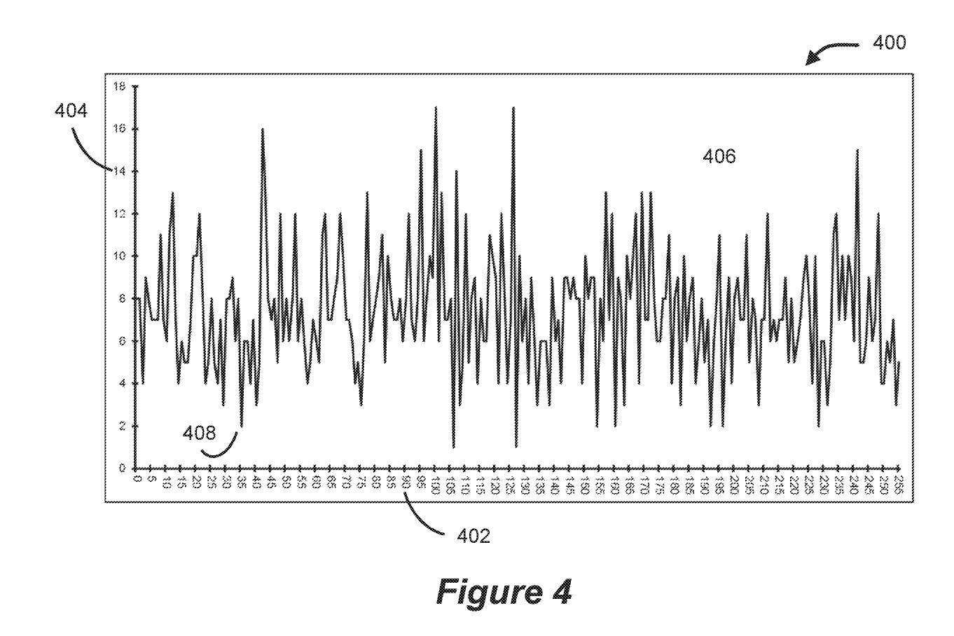

Referring to FIG. 4, which shows a graphical representation of an example byte value distribution 400, each distribution data point 406 has a position 402 in the distribution which corresponds to a possible byte value. In this example of 8-bit bytes, a byte can have a value in the range from zero to two hundred and fifty five (0 to 255), as shown on the graph, meaning that there are two hundred and fifty six (256) positions 402 in the distribution, or n=256 in the chi-squared equation. Each distribution data point 406 also has a frequency value 404, which is the frequency of that particular byte value in the byte sample i.e. the number of bytes in the byte sample that have the byte value corresponding to the distribution position 402. For example, as shown by the byte value distribution 400 in FIG. 4, there are two bytes in the byte sample that have a value of thirty five 408.

The byte value distribution 400 may be considered as a histogram distribution, where the possible byte values are binned, or grouped into bins or ranges, and the number of bytes having a value in each range is recorded. In the example of FIG. 4, the ranges are evenly distributed and span a value of one (1) i.e. each bin or range is equivalent to a discrete possible value that a byte in the byte sample could have.

In other embodiments, a sample subset based on different sample positions (for example, non-equidistant positions) in each executable program file 102, 104 may be determined. For example, frequency values for each bin may change as the set of sample points is changed, in a way which may correlate between two similar or related files. This correlation may be computed to determine the difference metric between the byte value distributions of the first and second executable program files 102, 104.

Other distributions are also possible: for example, determining a respective distribution of byte values from each byte sample may comprise computing a Fourier transform of the byte sample.

Referring back to FIG. 1, the byte sampler 106 is configured to determine whether the difference metric, between the first and second byte value distributions, indicates a similarity or dissimilarity between the first and second byte value distributions. For example, the byte sampler 106 may compute the difference metric as a chi-squared value, as described above, and compare this chi-squared value to a predetermined threshold. In examples where the chi-squared value is determined as described above, a lower chi-squared value indicates more similarity between the first and second byte value distributions than a higher chi-squared value does. Thus, a threshold can be set such that if the chi-squared value is determined by the byte sampler 106 to be less than (or less than or equal to) the threshold, the byte sampler 106 indicates a similarity between the first and second byte value distributions. In this example, if the chi-squared value is determined by the byte sampler 106 to be greater than or equal to (or greater than) the threshold, the byte sampler 106 indicates a dissimilarity between the first and second byte value distributions. In other examples, a higher difference metric value may indicate more similarity between the byte value distributions than a lower difference metric value. In these examples, if the difference metric is determined by the byte sampler 106 to be greater than or equal to (or greater than) the threshold, the byte sampler 106 indicates a similarity between the first and second byte value distributions. Otherwise, if the difference metric is determined to be less than (or less than or equal to) the threshold, a dissimilarity between the byte value distributions is indicated by the byte sampler 106.

In other embodiments, the byte sampler 106 may compute a Fourier series of harmonics associated with each byte sample 108, 110 and use Fourier analysis to compare the byte value distributions and determine the difference metric value. For example, the Fourier transform of each executable program file 102, 104 or each byte sample 108, 110 may be computed. Determining the difference metric may then comprise breaking up or “chunking” the Fourier transform spectral values over a plurality of time ranges, and comparing the corresponding values between the files associated with at least a subset of the plurality of time ranges.

The file import processor 114 is configured to receive an output from the byte sampler 106. For example, the byte sampler 106 may indicate a similarity or dissimilarity between the first and second byte value distributions and report the indication to the file import processor 114.

In other embodiments, the byte sampler 106 receives an output from the file import processor 114, which operates as herein described. Thus, the input/output chain may be reversed.

Responsive to an indication of similarity from the byte sampler, the file import processor 114 is configured to process file import sections 116, 118 of the first and second executable program files 102, 104. For example, the file import section 116 corresponding to the first executable program file 102 may comprise an import address table (IAT) of the first executable program file 102. Similarly the file import section 118 corresponding to the second executable program file 104 may comprise an import address table (IAT) of the second executable program file 104.

An IAT is a section of an executable program file which stores a lookup table of references to dynamic link libraries (DLLs) and application programming interfaces (APIs) used by the executable program file. An API is a set of routine functions that may be common to a number of different application programs; sometimes called the ‘building blocks’ that computer software and applications are built from. APIs are often stored in a library, known as a dynamic link library (DLL), which can be linked to by an application program that requires the functionality of the API routines stored in the library. Thus, instead of each application program having to compile the API routines it needs itself, the routines are stored once on the computer system and can then be exported to the application programs through linking via DLLs. The file import section 116, 118 is therefore a section of an executable program file 102, 104 which contains references to functions (APIs) within libraries (DLLs) that the executable program file 102, 104 imports. The DLLs and APIs may be referenced either by name or ordinal number.

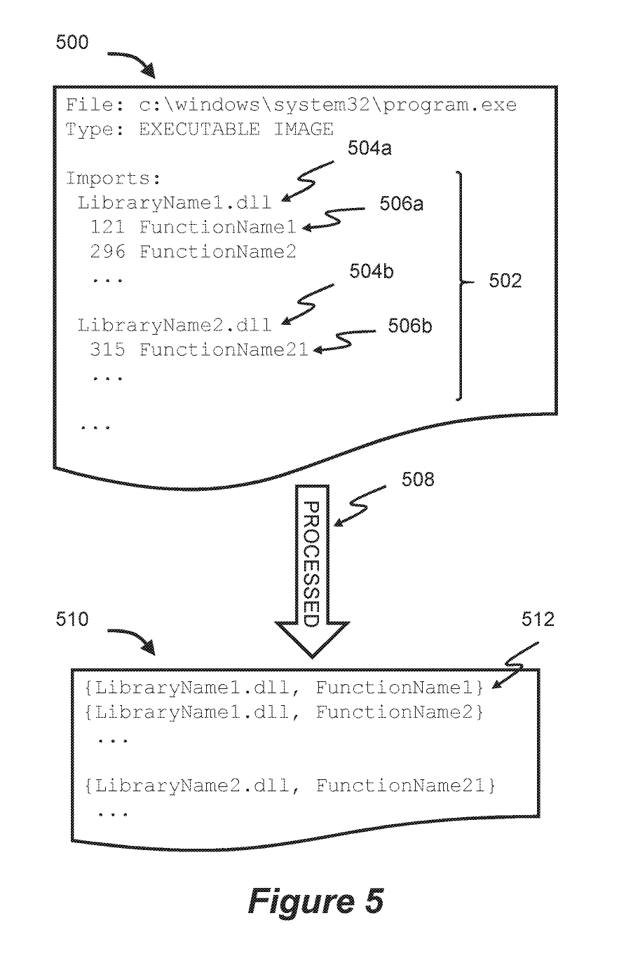

FIG. 5 shows a representation 500 of information associated with an executable program file program.exe on a Microsoft Windows® computer system. In this example, a utility program named “DUMPBIN” produced by Microsoft® has been used to analyses program.exe to output the representation 500, which comprises the file import section 502 of the executable program file. The file import section 502 comprises dynamic link library (DLL) references 504a, 504b . . . and application programming interface (API) function references 506a, 506b . . . which correspond to the DLL references 504a, 504b . . . . In this example, LibraryName1.dll is a file containing a library of functions FunctionName1, FunctionName2 etc. which are imported by program.exe. The file import section 502 of program.exe therefore displays a DLL reference to LibraryName1.dll 504a and references 506a to the API functions FunctionName1, FunctionName2 . . . corresponding to the DLL LibraryName1.dll. The API function references 506a, 506b also each contain a unique ordinal which may be used to reference a particular function instead of referencing the function's name. For example, FunctionName1 could be referenced by ordinal “121”. This is also the case for DLL references, which also may each have an ordinal number (not shown in FIG. 5). The use of ordinal numbers allows less memory, for example random access memory (RAM), to be used compared to referencing by name, since names are often much longer than ordinal numbers.

FIG. 5 shows the import section 502 being processed 508, and a set 510 of application programming interface references 512 determined by the file import processor 114. Each of the application programming interface references 512 is a data structure comprising one of the DLL references 504a, 504b . . . , and one of the corresponding API function references 506a, 506b . . . from the import section 502. In this example, the application programming interface references 512 are tuples: data structures containing two elements. The first element of each application programming interface reference 512 is one of the DLL references 504a, 504b . . . , and the second element is one of the corresponding API function references 506a, 506b . . . In other examples, the application programming interface reference data structures 512 may have more than two elements.

The file import processor 114 determines a set of application programming interface references for each of the first executable program file 102 and second executable program file 104. Each set may be an implantation of the exemplar set 510 of application programming interface references 512 shown in FIG. 5. The file import processor 114 is configured to output a similarity indication as a function of a number of matching entries in the sets of application programming interface references. Determining the number of matching entries in the sets of application programming interface references and/or performing a function on this number may be processed by an import comparison module 120 as part of the file import processor 114, as shown in FIG. 1. The similarity indication may comprise comparing the determined number of matching entries in the sets of application programming interface references to a predetermined threshold. For example, a threshold may be set such that if the number of matching entries is greater than (or greater than or equal to) the threshold, the file import processor 114 outputs an indication that the first and second executable files 102, 104 are similar. Otherwise, if the number of matching entries is less than or equal to (or less than) the threshold, the file import processor 114 outputs an indication that the first and second executable files 102, 104 are dissimilar.

The computer security utility 122 is configured to receive the similarity indication from the file import processor 114 and control execution of at least the second executable program file 104 based on said indication. As described, the byte sampler 106 and the file import processor may be swapped in their order of operation in some embodiments. For example, the file import processor 114 may operate as described to provide an indication of similarity as a function of a number of matching entries in the sets of application programming interface references of the executable program files 102, 104. This output indication may be received by the byte sampler 106 which operates as described to indicate a similarity or dissimilarity between the first and second byte value distributions, and report the indication to the computer security utility 122. In these embodiments, the computer security utility 122 may be configured to receive the similarity indication from the byte sampler 106 and control execution of at least the second executable program file 104 based on said indication.

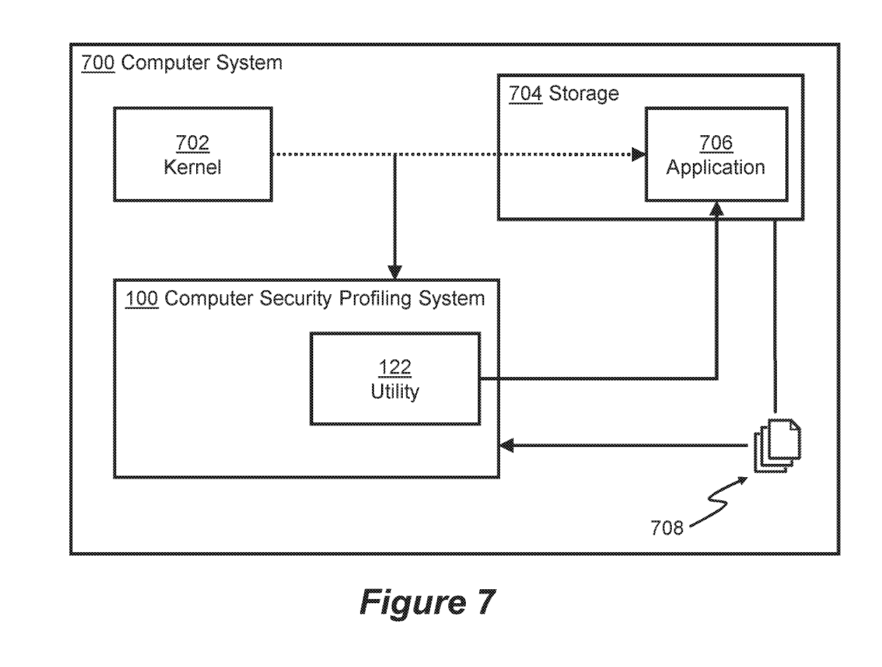

The computer security utility 122 is a utility software, i.e. a type of system software, which may interact with, or be comprised as part of, an operating system (OS) of a computer system to maintain security of the computer system. In some examples, the computer security utility 122 is an integrated component of the computer security profiling system 100, as shown in FIG. 7. In other examples, the computer security utility 122 may form part of the computer security profiling system 100 while being a component of the computer system, for example of the kernel or OS. In these examples, the computer security utility 122 may intercept calls, for example by the operating system, to execute or run an executable program file 102, 104 on the computer system. The file may then be suspended from being executed while the file is inspected by the computer security profiling system 100. The computer security utility 122 then has control of the execution of the executable program file 102, 104 at the OS level of the computer system, based on the output of the inspection by the computer security profiling system 100.

In some embodiments, the computer security utility 122 is configured to enable or prevent execution of at least the second executable program file 104 on a computing device depending on the similarity indication indicating a similarity between the first and second executable program files 102, 104.

For example, the first executable file 102 may be a software application that is permitted to run on a computer system, for example whitelisted, and the second executable file 104 may be an update to the software application of the first executable file 102, or a patch. The computer security utility 122 is therefore configured to receive an indication from the file import processor 114 that the patch is similar to the permitted/whitelisted software application, for example, and control execution of the second executable program file 104 by allowing it to run on the computer system.

In other examples, the second executable file 104 may be a malicious program, or malware. Thus, upon receiving an indication from the file import processor 114 that the malware is dissimilar to the software application of the first executable file 102, the computer security utility 122 is configured to prevent execution of the malware. In some other examples, the first executable file 102 is a known malicious or vulnerable program on the computer system, for example one that has been identified in a virus scan or other security method and/or has been blacklisted. Thus, upon receiving an indication from the file import processor 114 that the unknown second executable file 104 is similar to the first executable file 102, the computer security utility 122 is configured to prevent execution of at least the second executable file 104 i.e. the computer security utility 122 may also prevent execution of the first executable file 102. The second executable file 104 may then also be automatically blacklisted i.e. added to a blacklist of software not permitted to run on the computer system.

According to another aspect of the invention, there is provided a method of determining a similarity between two executable program files, for example first and second executable program files 102, 104, as shown in FIG. 1, for computer security profiling. The steps of such a method may correspond with the processes, routines etc. described herein with reference to the computer security profiling system 100 and its components.

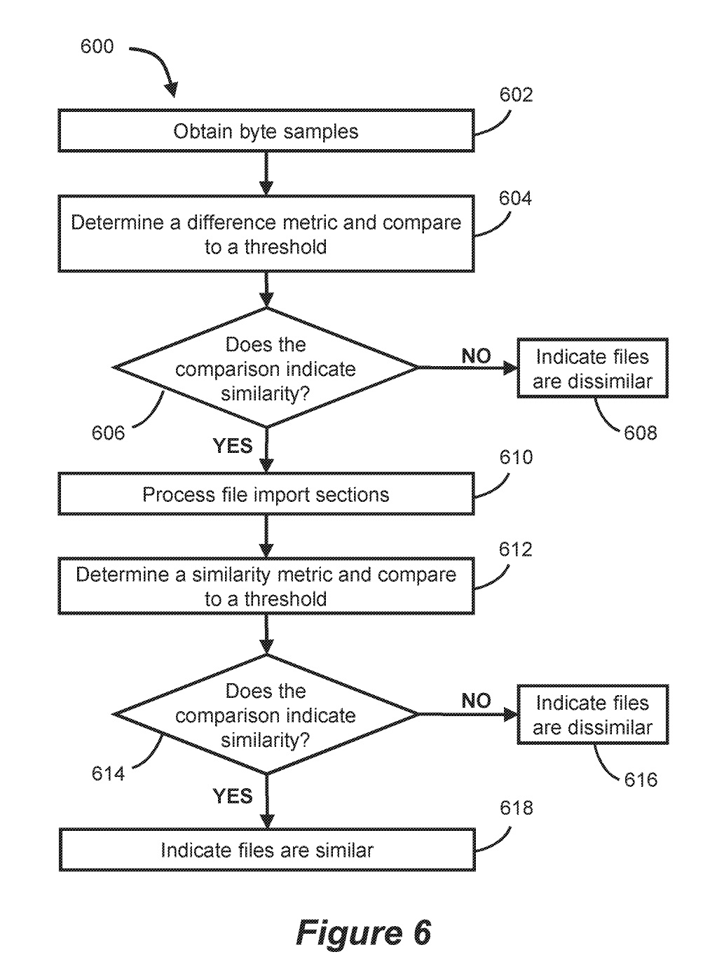

FIG. 6 shows a method 600 of determining a similarity between two executable program files. The method begins with the step 602 of obtaining a byte sample from each of a first and second executable program file. In certain examples, obtaining a byte sample from each of the first and second executable program file may comprise obtaining a sample of bytes that are located equidistantly from one another in each executable program file. In some of these examples, obtaining the sample of bytes may comprise sequentially obtaining a median byte from a set of bytes and bisecting the previous set to form two new sets. The set of bytes may correspond initially to a set of bytes forming each respective executable program file, and the obtaining and bisecting operations are repeated until a predetermined number of bytes is extracted.

The next step 604 comprises determining a respective distribution of byte values from each obtained byte sample and determining a difference metric between said distributions. In some examples, this step also comprises comparing the difference metric to a first predetermined threshold to indicate whether there is a similarity or dissimilarity between the distributions of byte values. In certain examples, determining the difference metric may comprise computing a chi-squared difference, or a chi-squared test value, and the second step 604 may therefore comprise comparing the determined chi-squared test value to the first threshold. In certain examples, the distribution of byte values from each byte sample comprises a histogram distribution.

A third step 606 comprises determining an indication of the difference metric. For example, the outcome of the comparison as part of the previous step 606 is interpreted to determine if the difference metric indicates the byte value distributions are similar or not. For example, the difference metric may be a chi-squared test value and thus if it were compared to the predetermined threshold in the previous second step 604 and found to be, in this example, less than the threshold, this may be interpreted in the third step 606 to indicate that the distributions are similar. Other comparison results are possible to set as indicators in the third step 606, for example how a difference metric value: equal to; higher than; or less than; the threshold is interpreted, which may depend on the difference metric used.

An optional step 608 comprises, responsive to the difference metric indicating a dissimilarity between the distributions, indicating, for example to a computer security utility, that the first and second executable program files are dissimilar.

Following on from the third step 606, a fourth step 610 comprises, responsive to the difference metric indicating a similarity between the distributions, processing file import sections of the first and second executable program files. In some examples, processing file import sections comprises processing respective import address tables and/or import name tables of the first and second executable program files. The file import sections are processed to determine a set of application programming interface references for each of the first and second executable program files. In certain examples, determining a set of application programming interface references may comprise obtaining, from the respective file import sections, one or more dynamic link library references and one or more corresponding application programming interface function references. Each entry in the respective sets of application programming interface references may comprise one of the dynamic link library references, and one of the corresponding application programming interface function references.

The fifth step 612 then comprises determining a similarity metric as a function of a number of matching entries in the sets of application programming interface references, and comparing the similarity metric to a predetermined threshold. For example, the similarity metric and the threshold may each be a numerical value for comparing to one another. In certain examples, determining the similarity metric comprises computing the metric as a function of the number of matching entries in the sets of application programming interface references of the first and second executable program files divided by a mean number of application programming interface references in the sets.

The sixth step 614 comprises determining an indication of the similarity metric. For example, the outcome of the comparison as part of the previous step 612 is interpreted in order to determine if the similarity metric indicates that the application programming interface references of the first and second executable files 102, 104 are similar or not. For example, different outcomes outputted from the comparison in the previous step 612 can be set to be interpreted in a particular way, such as how a similarity metric value: equal to; higher than; or less than; the threshold is to be interpreted.

Another optional step 616 comprises, responsive to the similarity metric indicating a dissimilarity between the application programming interface references, indicating that the executable program files are dissimilar.

Following the sixth step 614, a seventh step 618 comprises, responsive to the similarity metric indicating a similarity between the application programming interface references, indicating to a computer security utility that the first and second executable program files are similar. The computer security utility, which may be an implementation of the computer security utility 122 in the computer security profiling system 100 shown in FIG. 1 and herein described, may then operate in a predetermined way depending on the indication. For example, if the executable program files are determined to be similar or related and the first executable program file is known to be safe to run (it may be whitelisted on the computer system, or from a trusted source such as a major software developer, publisher, and/or distributor), then the second executable program file may be permitted to be run on the computer system also.

In some embodiments, the first, second and third steps 602, 604, 606 may be performed after the fourth, fifth and sixth steps 610, 612, 614. Thus, the two phases of the method: processing byte samples of the executable program files; and processing file import sections of the executable program files; may be reversed. For example, responsive to the similarity metric indicating a similarity between the application programming interface references in the file import section phase, the next byte sample phase may begin with obtaining byte samples 602. Following the step 606 comprising determining an indication of the difference metric, the seventh step 618 in this embodiment may comprise, responsive to the difference metric indicating a similarity between the byte value distributions, indicating to a computer security utility that the first and second executable program files are similar.

In certain examples, the computer security profiling comprises indicating executable program files that are allowed to be executed by a computing device in data comprising a whitelist. For example, the first executable program file may be indicated with said data comprising a whitelist, and in response to indicating to the computer security utility that the two executable program files are similar, execution of the second executable file by the computing device is enabled.

In other examples, the computer security profiling comprises scanning for malicious executable program files. For example, the first executable program file may be identified as malicious, and in response to indicating to the computer security utility that the two executable program files are similar, the second executable file is indicated to the computer security utility as malicious. The computer security utility may then prevent execution of the second executable file, may quarantine the file to prevent it harming the computing device, and/or may blacklist the file.

In other examples, the computer security profiling comprises scanning for vulnerable executable program files. For example, the first executable program file may be identified as comprising a vulnerability, and in response to indicating to the computer security utility that the two executable program files are similar, the second executable file is indicated to the computer security utility as comprising the vulnerability.

FIG. 7 shows an example of a computer system 700 comprising a kernel 702, a storage location 704 and a computer security profiling system 100, which may be an implementation of any computer security profiling system described herein, for example the one described with reference to FIG. 1.

The computer system 700 may comprise a computing device such as a personal computer, a hand held computer, a communications device e.g. a mobile telephone or smartphone, a data or image recording device e.g. a digital still camera or video camera, or another form of information device with computing functionality.

The computer system 700 comprises standard components not shown in FIG. 7, such as an operating system (OS) which comprises the kernel 702, a central processing unit (CPU), a memory e.g. random access memory (RAM) and/or read only memory (ROM), a basic input/output system (BIOS), a network interface for coupling the computer system to a communications network, and at least one bus for one or more input devices e.g. a keyboard and/or pointing device.

The kernel 702, operating at the lowest level of the OS, links application software, such as an application program 706 stored at the storage location 704, to hardware resources of the computer system 700, such as the CPU and RAM. For example, the application program 706 is stored at the storage location 704, and following a call from the kernel 702, is processed by the CPU to execute its instructions.

The storage location 706 may be a permanent memory such as an HDD or a SSD, or a location or partition thereof.

The computer security utility 122 may be a component of the OS, or of the kernel 702, or an integrated component of the computer security profiling system 100, as shown in FIG. 7. Therefore, in some examples, the computer security utility 122 may communicate with the computer security profiling system 100 internally, whereas in other examples the computer security utility 122 may communicate with the computer security profiling system 100 externally from within the OS or kernel 702.

In the example shown in FIG. 7, the computer security utility 122 of the computer security profiling system 100 intercepts calls by the kernel 702, as part of the OS, to execute or run the application program 706: the application program 706 comprises an executable program file, which is called by the kernel to be processed by the CPU. The intercept may be caused by identification by the OS or the computer security utility 122 that the application program 706 is unrecognized, or has not been run on the computer system 700 before. For example, this may be a result of a scan or in response to the application program 706 being called to run on the computer system 700 for the first time. The execution call is suspended while the computer security profiling system 100 inspects the executable program file corresponding to the application program file 706.

The computer security profiling system 100 operates according to the examples, and/or implements the methods relating to computer security profiling described herein, where the second executable program file 104 may correspond to the application program file 706 being called to be executed.

Executable program files 708, which may be implementations of the first executable program file 102 and the second executable program file 104 described in examples, are obtained from the storage location 704. In this example, the executable program files 708 are stored at the same storage location 704. In other examples, the individual executable program files 102, 104 may be stored at different storage locations, for example on different memory devices or in different directories on the same memory device.

The computer security profiling system 100 profiles the executable program files 708, for example to determine if they are similar or related to one another by the methods described herein, and provides an indication to the computer security utility 122. The computer security utility 122 controls the execution of at least the second executable program file 104, associated with the application program 706. For example, based on a particular indication from the computer security profiling system 100, the computer security utility 122 is configured to enable or prevent execution. This control by the computer security utility 122 may be implemented, in some examples, by forwarding or cancelling the call or request from the kernel 702 to execute the application program 706.

In some examples, the first executable program file 102 may correspond to an application program that is deemed safe to run by the computer security profiling system 100 or computer security utility 122, or may be whitelisted such that the OS is permitted to run the program. In these examples, after indication from the computer security profiling system 100 that the second executable program file 104 is similar or related to the first executable program file 102, the computer security utility 122 may enable execution of the second executable program file 104, and the application program is permitted to run (as originally requested by the kernel 702). However, after indication from the computer security profiling system 100 that the second executable program file 104 is dissimilar or unrelated to the first executable program file 102, the computer security utility 122 may prevent execution of the second executable program file 104.

In other examples, the first executable program file 102 may correspond to an application program that is deemed unsafe to run by the computer security profiling system 100 or computer security utility 122, for example due to an identified vulnerability or malicious code, or the file may be blacklisted such that the OS is not permitted to run the program. In these examples, after indication from the computer security profiling system 100 that the second executable program file 104 is similar or related to the first executable program file 102, the computer security utility 122 may prevent execution of the second executable program file 104, and the application program is not permitted to run. However, after indication from the computer security profiling system 100 that the second executable program file 104 is dissimilar or unrelated to the first executable program file 102, the computer security utility 122 may enable execution of the second executable program file 104.

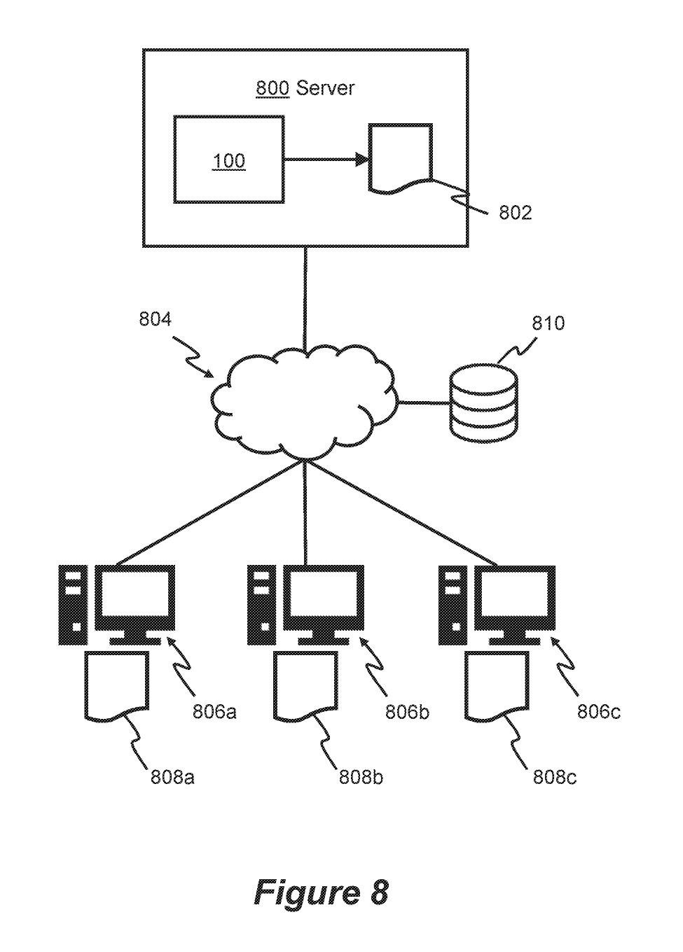

FIG. 8 shows a server 800 comprising the computer security profiling system 100 described previously, and a whitelist 802. The server 800 is communicatively coupled to a network 804. The network 804 may comprise a local area network (LAN) or wide area network (WAN) and/or wireless equivalents. In this example the server 800 runs on a dedicated computer communicatively coupled to the network 804.

One or more computer devices 806a, 806b, 806c are also connected to the network 804. Each of the computer devices 806a, 806b, 806c may be one of the examples previously described (personal or handheld computer, mobile communications device etc.) and may each have its own software, for example OS and application programs; and hardware, for example CPU, RAM, HDD, input/output devices etc.

Each of the computer devices 806a, 806b, 806c stores a corresponding local whitelist 808a, 808b, 808c. Each whitelist 808a, 808b, 808c comprises a list of application programs that are permitted to be run on the corresponding computer device 806a, 806b, 806c. The whitelist 808a, 808b, 808c of each computer device 806a, 806b, 806c may be maintained by the OS of the corresponding computer device 806a, 806b, 806c.

The whitelist 802 on the server 800 is a global whitelist. Thus, each local whitelist 808a, 808b, 808c on the networked computer devices 806a, 806b, 806c may comprise, as a minimum, the global whitelist 802 maintained by the server 800. The local whitelists 808a, 808b, 808c may be automatically updated with any changes to the global whitelist 802 on the server 800.

A storage device or medium 810 may also be connected to the network 804, as shown in FIG. 8. This storage device 810 may, for example, comprise an HDD or SSD which can be accessed by the one or more computer devices 806a, 806b, 806c. Thus, application programs may be stored in memory on the individual computer devices 806a, 806b, 806c, or may be stored centrally on the storage device 810 connected to the network 804 for access by the computer devices 806a, 806b, 806c.

The computer security profiling system 100 may operate in a number of ways on the network 804. For example, the computer security profiling system 100 may monitor calls or requests from the kernels of the computer devices 806a, 806b, 806c on the network, and intercept if the call is to run an application program unrecognized on the network 804 e.g. by the server 800. In this example, the computer security profiling system 100 operates in a similar way to the example described in FIG. 7, however the storage location for obtaining the executable program files, and the determination by the computer security profiling system 100, may be external to the networked computer devices 806a, 806b, 806c. In other examples, the computer security profile system 100 may scan the network 804, or a part of the network 804, for example the shared storage device 810 and/or one or more connected computer devices 808a 808b, 808c. In other examples, the computer security profiling system 100 may receive requests to operate, for example to determine similarity between two executable program files, from a computer device, such as one of the networked computer devices 806a, 806b, 806c.

In some examples, the computer security utility 122 of the computer security profiling system 100 may be located on the server 800 from where it may communicate with the kernel of each computer device 806a, 806b, 806c. In these examples, the computer security utility 122 may control execution of application programs on a networked computer device 806a, 806b, 806c by communicating with the corresponding kernel on the computer device 806a, 806b, 806c after receiving an indication from the computer security profiling system 100 at the server 100. For example, depending on the indication, the computer security utility 122 may cancel the kernel's execution call or may request that the kernel resend the call (after whitelisting the application program, such that the request is not intercepted the next time).

In other examples, each computer device 806a, 806b, 806c comprises a computer security utility 122, which communicates with the kernel of its host computer device 806a, 806b, 806c and with the remainder of the computer security profiling system 100 located at the server 800. In these examples, execution of application programs on a networked computer device 806a, 806b, 806c may be controlled directly by the computer security utility 122 after indication by the remainder of the computer security profiling system 100 at the server 800.

In the example shown in FIG. 8, the server 800 maintains a global whitelist 802. Thus, there may be an application program stored on the network, for example on the shared storage device 810, which is present on the global whitelist 802. A second application program may be identified on the network, for example by one of the computer devices 806a, 806b, 806c, or via a scan, which is unrecognized. Using the computer security profiling system 100, the executable program file corresponding with the second application program may be compared to the executable program file corresponding with the first application program to determine if the executable program files are similar or related. If the determination is that the files are similar, the computer security profiling system 100 may update the global whitelist 802 to include the second application program.

In other examples, the server 800 may comprise a global blacklist in addition to, or instead of, the global whitelist 802. Similarly, the computer devices 806a, 806b, 806c may store a local corresponding blacklist. Each blacklist is a list of application programs (executable program files) which are not permitted to run on the associated computer device. Each local blacklist comprises, as a minimum, the global blacklist maintained on the sever 800. The local blacklists may be automatically synchronized with the global blacklist, for example at regular intervals. In these examples the first executable program file 102, comprised in the executable program files 708 retrieved from the storage location 704, may be on the blacklist. Thus, if the indication from the computer security profiling system 100 is that the second executable file 104, comprised in the retrieved executable program files 708, is similar or related to the first executable file 102, the second executable file 104 may be added to the global blacklist and thus prevented from being run on any of the networked computer devices 806a, 806b, 806c.

Examples as described herein may be implemented by a suite of computer programs which are run on one or more computer devices of the network. Software provides an efficient technical implementation that is easy to reconfigure; however, other implementations may comprise a hardware-only solution or a mixture of hardware devices and computer programs. One or more computer programs that are supplied to implement the invention may be stored on one or more carriers, which may also be non-transitory. Examples of non-transitory carriers include a computer readable medium for example a hard disk, solid state main memory of a computer, an optical disc, a magneto-optical disk, a compact disc, a magnetic tape, electronic memory including Flash memory, ROM, RAM, a RAID or any other suitable computer readable storage device.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of determining a similarity between two executable program files for computer security profiling, the method comprising:
obtaining a byte sample from each of a first and second executable program file;
determining a respective distribution of byte values from each byte sample, and a difference metric between said distributions; and
responsive to the difference metric indicating a similarity between the distributions:
processing file import sections of the first and second executable program files to determine a set of application programming interface references for each of the first and second executable program files;
determining a similarity metric as a function of a number of matching entries in the sets of application programming interface references; and
responsive to the similarity metric indicating a similarity between the application programming interface references, indicating to a computer security utility that the first and second executable program files are similar.

2. The method according to claim 1, wherein the method comprises, responsive to the difference metric indicating a dissimilarity between the distributions, indicating to a computer security utility that the first and second executable files are dissimilar.

3. The method according to claim 1, wherein determining the similarity metric comprises computing the metric as a function of the number of matching entries in the sets of application programming interface references divided by a mean number of application programming interface references in the sets.

4. The method according to claim 1, wherein obtaining a byte sample comprises obtaining a sample of bytes that are located equidistantly from one another in each executable program file.

5. The method according to claim 4, wherein obtaining the sample of bytes comprises obtaining a first boundary byte and a second boundary byte, and recursively obtaining a median byte from between each neighboring pair of previously obtained bytes until a predetermined number of bytes is obtained.

6. The method according to claim 5, wherein the first boundary byte corresponds to the first byte of the executable program file and the second boundary byte corresponds to the last byte of the executable program file.

7. The method according to claim 1, wherein a distribution of byte values from a byte sample comprises a histogram distribution.

8. The method according to claim 1, wherein determining a respective distribution of byte values from each byte sample comprises computing a Fourier transform of the byte sample.

9. The method according to claim 1, wherein determining a difference metric between distributions of byte values comprises computing a chi-squared difference.

10. The method according to claim 1, wherein the method comprises comparing the difference metric to a first threshold to indicate whether there is a similarity or dissimilarity between the distributions of byte values.

11. The method according to claim 1, wherein processing file import sections comprises processing respective import address tables and/or import name tables of the first and second executable program files.

12. The method according to claim 1, wherein determining a set of application programming interface references comprises obtaining, from the respective file import section:
one or more dynamic link library references; and
one or more corresponding application programming interface function references.

13. The method according to claim 12, wherein each entry in the respective sets of application programming interface references comprises:
one of the dynamic link library references, and;
one of the corresponding application programming interface function references.

14. The method according to claim 1, wherein:
the computer security profiling comprises indicating executable program files that are allowed to be executed by a computing device in data comprising a whitelist;
the first executable program file is indicated with said data comprising a whitelist; and
in response to indicating to the computer security utility that the two executable program files are similar, execution of the second executable file by the computing device is enabled.

15. The method according to claim 1, wherein:
the computer security profiling comprises scanning for malicious executable program files;
the first executable program file is identified as malicious; and
in response to indicating to the computer security utility that the two executable program files are similar, the second executable file is indicated to the computer security utility as malicious.

16. The method according to claim 1, wherein:
the computer security profiling comprises scanning for vulnerable executable program files;
the first executable program file is identified as comprising a vulnerability; and
in response to indicating to the computer security utility that the two executable program files are similar, the second executable file is indicated to the computer security utility as comprising the vulnerability.

17. A computer security profiling system comprising:
a byte sampler to access at least one file storage location and obtain a byte sample from each of a first and second executable program file located in the at least one file storage location, the byte sampler being configured to:
determine a distribution of byte values for each of the first and second byte samples;
determine a difference metric between the first and second byte value distributions; and
determine whether the difference metric indicates a similarity or dissimilarity between the distributions;
a file import processor to receive an output of the byte sampler and, responsive to an indication of similarity from the byte sampler, to:
process file import sections of the first and second executable program files;
determine respective sets of application programming interface references; and
output a similarity indication as a function of a number of matching entries in the sets of application programming interface references; and
a computer security utility to receive the similarity indication from the file import processor and control execution of at least the second executable program file based on said indication.

18. The computer security profiling system according to claim 17, wherein the computer security utility is configured to enable or prevent execution of at least the second executable program file on a computing device responsive to the similarity indication indicating a similarity between the first and second executable program files.

19. A non-transitory computer-readable medium comprising computer-executable instructions which, when executed by a processor, cause a computing device to perform a method of determining a similarity between two executable program files for computer security profiling, the method comprising:
obtaining a byte sample from each of a first and second executable program file;
determining a respective distribution of byte values from each byte sample, and a difference metric between said distributions; and
responsive to the difference metric indicating a similarity between the distributions:
processing file import sections of the first and second executable program files to determine a set of application programming interface references for each of the first and second executable program files;
determining a similarity metric as a function of a number of matching entries in the sets of application programming interface references; and
responsive to the similarity metric indicating a similarity between the application programming interface references, indicating to a computer security utility that the first and second executable program files are similar.
